(19) United States
(12) Patent Application Publication
(10) Pub. No.: US 2025/0279582 A1
(43) Pub. Date: Sep. 4, 2025

(54) ANTENNA DEVICE

(71) Applicant: TDK Corporation, Tokyo (JP)

(72) Inventor: Kenichi TEZUKA, Tokyo (JP)

(73) Assignee: TDK Corporation, Tokyo (JP)

(21) Appl. No.: 19/069,378

(22) Filed: Mar. 4, 2025

(30) Foreign Application Priority Data
Mar. 4, 2024 (JP) 2024-032005

(51) Int. Cl. H01Q 5/307; H01Q 9/28

(52) U.S. Cl. CPC H01Q 5/307; H01Q 9/28

(57) ABSTRACT

Disclosed herein is an antenna device that includes a substrate, a ground conductor formed on the substrate, first and second antenna conductor patterns arranged in a ground clearance area on the substrate, and a capacitive element connecting the first and second antenna conductor patterns. The first antenna conductor pattern includes a first radiation pattern extending in a first direction from a first feed point. When a wavelength with respect to a center frequency of an electromagnetic wave in wireless communication using the first antenna conductor pattern is λ, the capacitive element is connected within a range between +λ/20 from a center position of the first radiation pattern in the first direction.

### CROSS-REFERENCE TO RELATED APPLICATION

This application claims the benefit of Japanese Patent Application No. 2024-032005, filed on Mar. 4, 2024, the entire disclosure of which is incorporated by reference herein.

### BACKGROUND

The present disclosure relates to an antenna device and, more particularly, to an antenna device having a plurality of antenna conductor patterns.

JP 2004-201278A discloses a pattern antenna including a printed board having a ground pattern, a reverse F-shaped antenna, and a reverse L-shaped antenna. The reverse F-shaped and reverse L-shaped antennas are disposed on the surface of the printed board at the end portion thereof where the ground pattern is not provided. In JP 2004-201278A, the reverse L-shaped antenna pattern has a stub pattern so as to adjust coupling between the reverse F-shaped and reverse L-shaped antennas.

However, it is difficult to achieve sufficient isolation between the antennas while reducing return loss by the adjustment using the stub pattern.

### SUMMARY

An antenna device according to an aspect of the present disclosure includes a substrate, a ground conductor formed on the substrate, first and second antenna conductor patterns arranged in a ground clearance area on the substrate, and a capacitive element connecting the first and second antenna conductor patterns. The first antenna conductor pattern includes a first radiation pattern extending in a first direction from a first feed point. When a wavelength with respect to a center frequency of an electromagnetic wave in wireless communication using the first antenna conductor pattern is A, the capacitive element is connected within a range between +λ/20 from a center position of the first radiation pattern in the first direction.

### BRIEF DESCRIPTION OF THE DRAWINGS

The above features and advantages of the present disclosure will be more apparent from the following description of certain embodiments taken in conjunction with the accompanying drawings, in which:

FIG. 1 is a schematic plan view illustrating the outer appearance of an antenna device 1 according to a first embodiment of the technology described herein;

FIG. 2 is an enlarged view of the ground clearance area 4;

FIGS. 3A to 3C are schematic diagrams for explaining several methods of connecting the capacitive element C;

FIGS. 4A and 4B are graphs illustrating return loss of the antenna device 1;

FIGS. 5A and 5B are graphs illustrating isolation of the antenna device 1;

FIGS. 6A and 6B are graphs illustrating gain of the antenna device 1;

FIGS. 7A and 7B are graphs illustrating radiation efficiency of the antenna device 1;

FIG. 8 is a schematic plan view illustrating the outer appearance of an antenna device 1A according to a first comparative example;

FIGS. 9A and 9B are graphs illustrating return loss of the antenna device 1A;

FIG. 10 is a graph illustrating isolation of the antenna device 1A;

FIG. 11 is a schematic plan view illustrating the outer appearance of an antenna device 1B according to a second comparative example;

FIGS. 12A and 12B are graphs illustrating return loss of the antenna device 1B; and

FIG. 13 is a graph illustrating isolation of the antenna device 1B.

### DETAILED DESCRIPTION OF THE EMBODIMENTS

The present disclosure relates to an antenna device having a plurality of antenna conductor patterns in a ground clearance area on a substrate and describes a technology for achieve sufficient antenna isolation.

Some embodiments of the present disclosure will be explained below in detail with reference to the accompanying drawings.

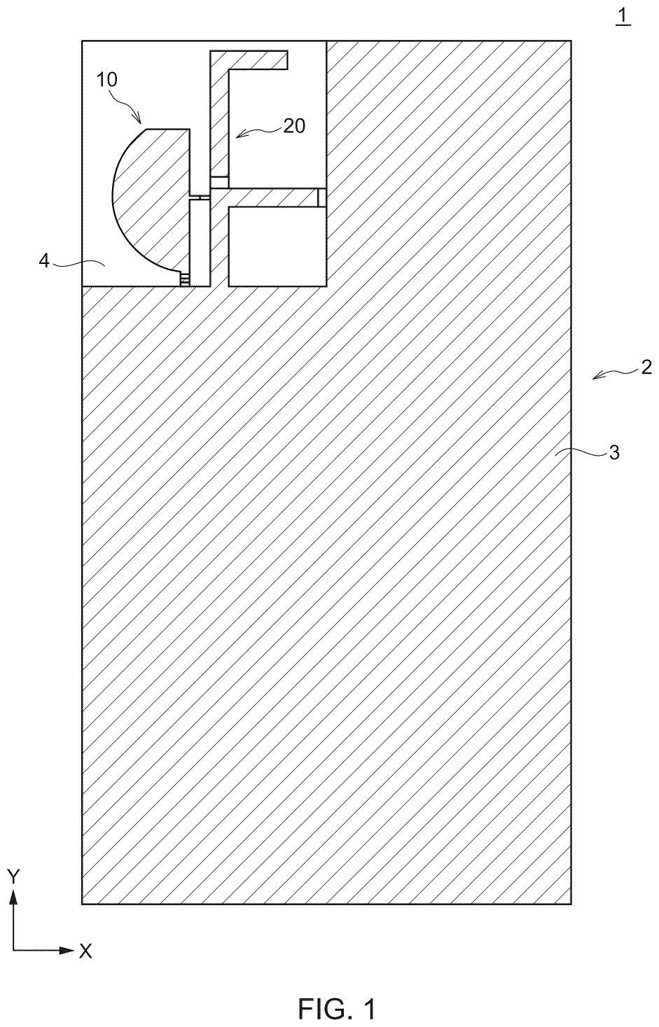

FIG. 1 is a schematic plan view illustrating the outer appearance of an antenna device 1 according to a first embodiment of the technology described herein.

As illustrated in FIG. 1, the antenna device 1 according to the present embodiment has a substrate 2 made of an insulating material such as resin, a ground conductor 3 formed on the surface of the substrate 2, and antenna conductor patterns 10 and 20 disposed in a ground clearance area 4 obtained by cutting out the ground conductor 3. That is, the ground clearance area 4 is an area where the ground conductor 3 is not formed. In the example illustrated in FIG. 1, a large part of the substrate 2 is covered with the ground conductor 3. The antenna conductor pattern 10 is, for example, a first antenna conductor pattern, and the antenna conductor pattern 20 is, for example, a second antenna conductor pattern. The antenna conductor patterns 10 and 20 are arranged in the X-direction.

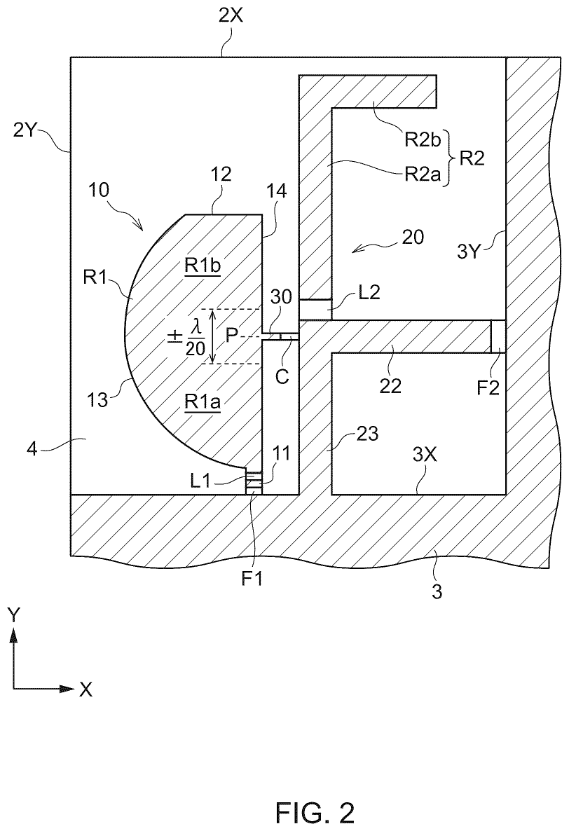

FIG. 2 is an enlarged view of the ground clearance area 4.

As illustrated in FIG. 2, the ground clearance area 4 is an area surrounded by an edge 2X extending in the X-direction of the substrate 2, an edge 2Y extending in the Y-direction of the substrate 2, an edge 3X extending in the X-direction of the ground conductor 3, and an edge 3Y extending in the Y-direction of the ground conductor 3. The ground clearance area 4 is a rectangular area defined by the edges 2X and 2Y of the substrate 2 and 3X and 3Y of the ground conductor 3. The Y-direction is, for example, a first direction, and the X-direction is, for example, a second direction. The edge 3Y is, for example, a first edge of the ground conductor 3, and the edge 3X is, for example, a second edge of the ground conductor 3. Thus, in the example illustrated in FIG. 2, the ground clearance area 4 is surrounded by the ground conductor 3 from one side in the X-direction and one side in the Y-direction; however, the ground clearance area 4 may be surrounded from three sides. For example, the ground clearance area 4 may be surrounded by the ground conductor 3 from one side in the X-direction and both sides in the Y-direction.

The antenna conductor pattern 10 includes a conductor pattern 11 and a radiation pattern R1. The conductor pattern 11 is connected to a feed point F1 positioned on the edge 3X of the ground conductor 3 at its one end in the Y-direction and to the radiation pattern R1 through an inductance element L1 at its other end in the Y-direction. The conductor pattern is, for example, a first conductor pattern, the radiation pattern R1 is, for example, a first radiation pattern, the inductance element L1 is, for example, a first inductance element, and the feed point F1 is a first feed point. The inductance element L1 may be a two-terminal type chip component mounted on the substrate 2 or a conductor pattern formed on the substrate 2.

The radiation pattern R1 has an opening end 12 positioned on the opposite side of the feed point F1 in the Y-direction. In the example illustrated in FIG. 2, the opening end 12 linearly extends in the X-direction. An edge 13 of the radiation pattern R1 connecting the end portion of the opening end 12 in the negative X-direction and a connection portion connected to the inductance element L1 has a convex curved shape. That is, when the end portion of the opening end 12 in the negative X-direction is assumed to be a starting point, the position of the edge 13 gradually shits in the negative X-direction toward the connection portion connected to the inductance element L1 and then gradually shifts in the positive X-direction from the leftmost point of the edge 13 in the X-direction toward the connection portion connected to the inductance element L1. The shift amount of the edge 13 in the X-direction with respect to the unit Y-direction position gradually reduces from the end portion of the opening end 12 in the negative X-direction toward the leftmost point of the edge 13 in the X-direction and gradually increases from the leftmost point of the edge 13 in the X-direction toward the connection portion connected to the inductance element L1. The leftmost point of the edge 13 in the X-direction may be positioned at the center of the radiation pattern R1 in the Y-direction. On the other hand, an edge 14 of the radiation pattern R1 connecting the end portion of the opening end 12 in the positive X-direction and connection portion connected to the inductance element L1 linearly extends in the Y-direction.

As a result, the radiation pattern R has a shape including an area R1a positioned on the negative Y-direction side and gradually increasing in X-direction width from the feed point F1 toward the Y-direction center position of the radiation pattern R1 and a region R1b gradually reducing in X-direction width from the Y-direction center position of the radiation pattern R1 toward the opening end 12. With such a shape, the radiation pattern R1 can achieve satisfactory characteristics as an antenna for a UWB (Ultra Wide Band) system. It is not essential to use the inductance element L1 for the antenna conductor pattern 10; however, using the inductance element L1 allows miniaturization of the radiation pattern R1 and reduction in return loss.

The antenna conductor pattern 20 includes a conductor pattern 22, a conductor pattern 23, and a radiation pattern R2. The conductor pattern 22 extends in the negative X-direction from a feed point F2 positioned on the edge 3Y of the ground conductor 3 toward the antenna conductor pattern 10. The conductor pattern 23 extends in the negative Y-direction from the end portion of the conductor pattern 22 in the negative X-direction toward the edge 3X of the ground conductor 3. The radiation pattern R2 extends in the positive Y-direction from a connection point between the conductor patterns 22 and 23 toward the opposite side of the edge 3X of the ground conductor 3. The conductor pattern 22 is, for example, a second conductor pattern, the conductor pattern 23 is, for example, a third conductor pattern, the radiation pattern R2 is, for example, a second radiation pattern, and the feed point F2 is, for example, a second feed point. The end portion of the conductor pattern 23 in the negative Y-direction may be connected to the edge 3X of the ground conductor 3.

In the example illustrated in FIG. 2, the pattern widths of the conductor patterns 22 and 23 constituting the antenna conductor pattern 20 and the radiation pattern R2 are substantially fixed and larger than the pattern width of the conductor pattern 11 constituting the antenna conductor pattern 10.

In the example illustrated in FIG. 2, there is disposed an inductance element L2 having one end connected to the radiation pattern R2 and the other end connected to a connection point between the conductor patterns 22 and 23. The inductance element L2 may be a two-terminal type chip component mounted on the substrate 2 or a conductor pattern formed on the substrate 2. The inductance of the inductance element L2 may be larger than that of the inductance element L1. In this case, it is possible to achieve a sufficient inductance by using a two-terminal type chip component as the inductance element L2. It is not essential to use the inductance element L2 for the antenna conductor pattern 20; however, using the inductance element L2 allows miniaturization of the radiation pattern R2 and reduction in return loss.

The radiation pattern R2 includes a first part R2a extending in the positive Y-direction from the inductance element L2 and a second part R2b extending in the positive X-direction from the leading end of the first part R2a in the positive Y-direction toward the edge 3Y of the ground conductor 3. The leading end of the second part R2b in the positive X-direction is separated from the edge 3Y of the ground conductor 3.

The antenna conductor pattern 20 having such a shape constitutes a reverse F-shaped antenna and can achieve satisfactory characteristics as an antenna for Bluetooth®. It is not essential to form the radiation pattern R2 in a bent shape including the first and second parts R2a and R2b; however, forming the radiation pattern R2 in a bent shape allows reduction in the Y-direction length of the radiation pattern R2.

Further, the antenna device 1 according to the present embodiment has a capacitive element connecting the antenna conductor patterns 10 and 20. The capacitive element C may be a two-terminal type chip component mounted on the substrate 2 or a conductor pattern formed on the substrate 2. One end of the capacitive element C is connected to the radiation pattern R1 of the antenna conductor pattern 10, and the other end thereof is connected to a connection point between the conductor patterns 22 and 23 of the antenna conductor pattern 20. The connection point between the conductor patterns 22 and 23 is positioned between the inductance element L2 and feed point F2.

The capacitive element C acts to cancel inductive coupling generated by adjacent arrangement between the antenna conductor patterns 10 and 20. This reduces inductive coupling between the antenna conductor patterns 10 and 20, which improves isolation between the antenna conductor patterns 10 and 20. The effect obtained by the capacitive element C becomes maximum when the capacitive element C is connected to a center position P of the radiation pattern R1 in the Y-direction. However, it is not essential to connect the capacitive element C to the center position P. Instead, when a wavelength with respect to the center frequency of an electromagnetic wave in wireless communication using the antenna conductor pattern 10 is λ, the capacitive element C is connected within a range between ±λ/20 from the center position P of the radiation pattern R1 in the Y-direction, whereby the effect obtained by the capacitive element C becomes sufficient. A portion at which the width of the radiation pattern R1 becomes maximum may also be positioned within the range between ±λ/20 from the center position P.

For example, when the Y-direction length of the radiation pattern R1 is 7.4 mm, and λ is 41 mm, it is possible to obtain the effect of canceling the inductive coupling by connecting the capacitive element C within a range of ±2.05 mm from the center position P.

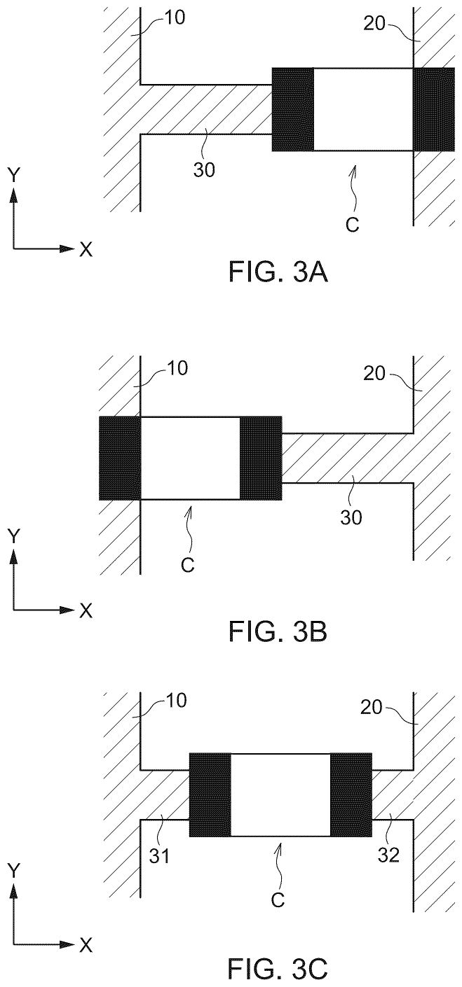

One and the other ends of the capacitive element C may be connected to the antenna conductor patterns 10 and 20 directly or through a connection pattern 30. For example, the following configurations illustrated in FIGS. 3A to 3C may be employed: the connection pattern 30 is provided to the antenna conductor pattern 10 so as to extend in the X-direction, and the capacitive element C is connected between the connection pattern 30 and antenna conductor pattern 20 (FIG. 3A); the connection pattern 30 is provided to the antenna conductor pattern 20 so as to extend in the X-direction, and the capacitive element C is connected between the connection pattern 30 and antenna conductor pattern 10 (FIG. 3B); and connection patterns 31 and 32 are provided respectively to the antenna conductor patterns 10 and 20 so as to extend in the X-direction, and the capacitive element C is connected between the connection patterns 31 and 32.

The pattern widths of the connection patterns 30 to 32 may be smaller than the pattern width of the antenna conductor pattern 20. This can reduce influence that the connection patterns 30 to 32 have on the characteristics of the antenna conductor patterns 10 and 20.

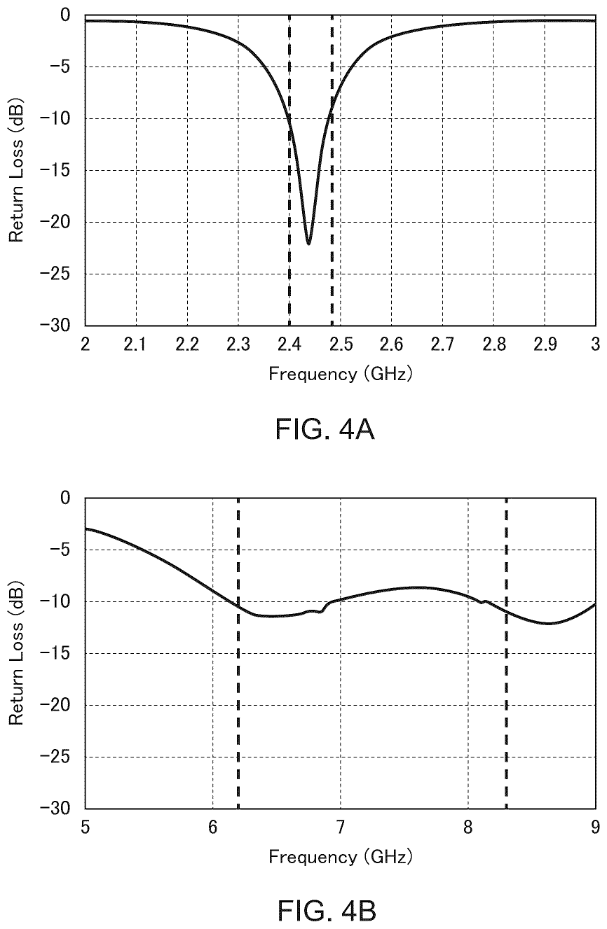

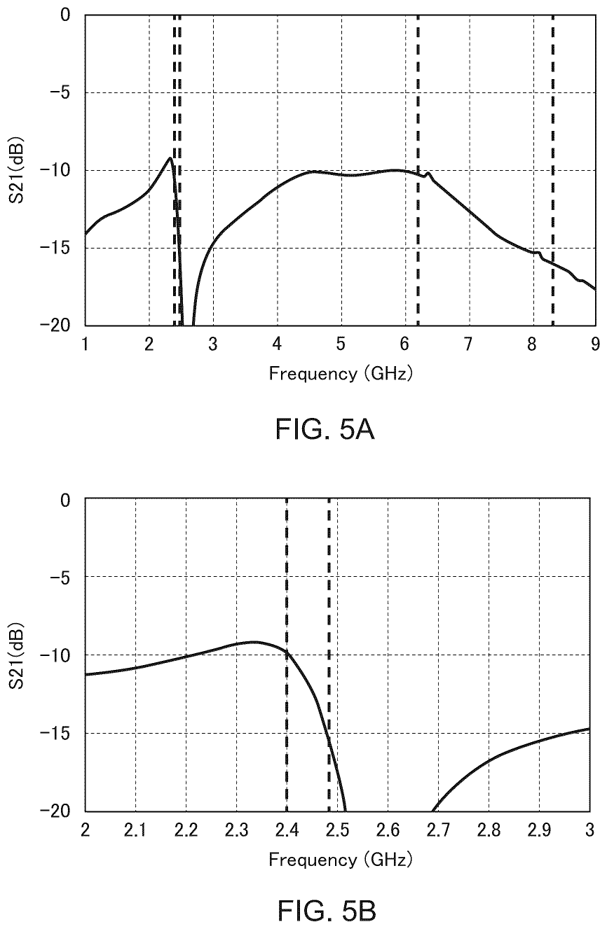

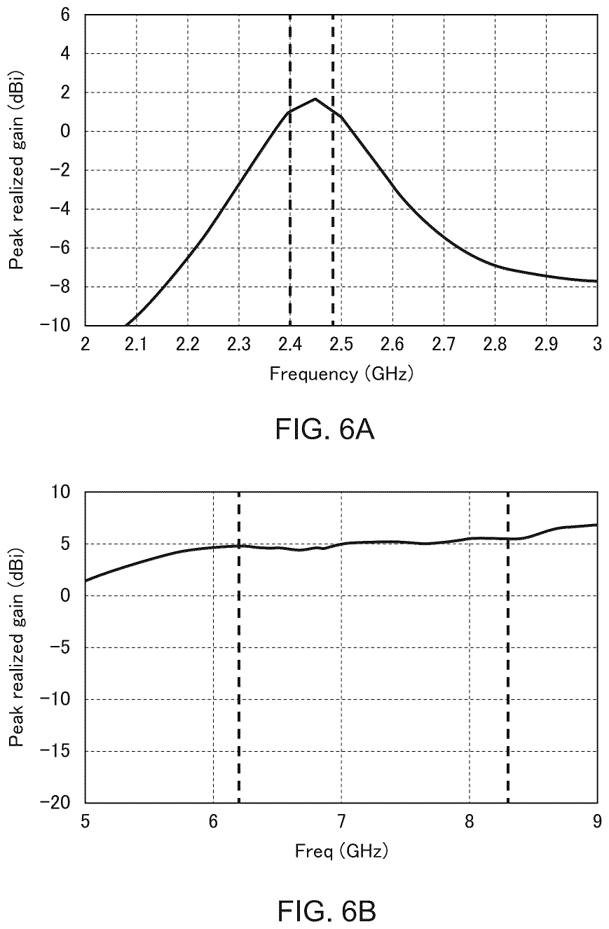

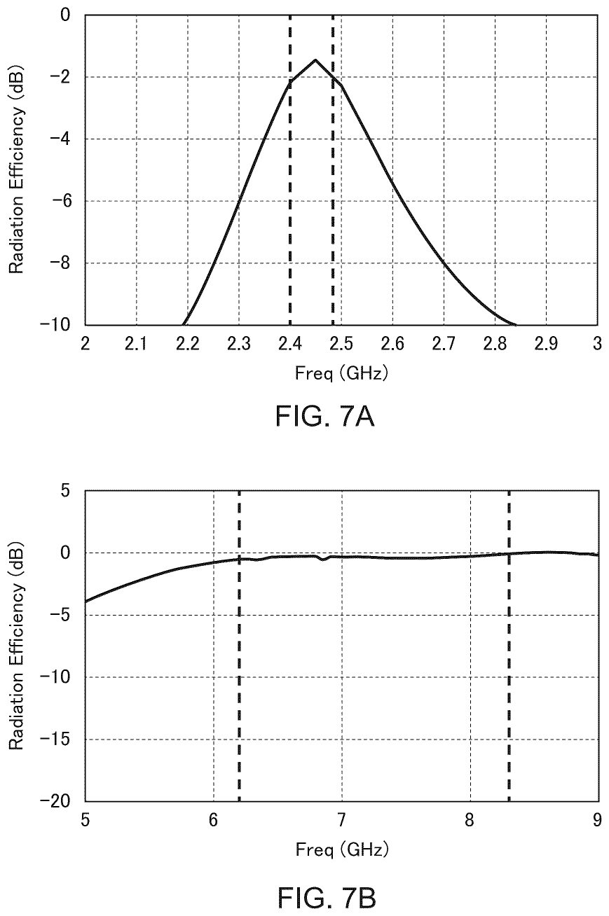

FIGS. 4A and 4B to FIGS. 7A and 7B are graphs illustrating the characteristics of the antenna device 1 according to the present embodiment. FIGS. 4A, 6A, and 7A illustrate the characteristics of the antenna conductor pattern 20, and FIGS. 4B, 6B, and 7B illustrate the characteristics of the antenna conductor pattern 10. FIG. 5A illustrates the characteristics of both the antenna conductor patterns 10 and 20, and FIG. 5B illustrates the characteristics of the antenna conductor pattern 20. More specifically, FIGS. 4A and 4B illustrate return loss, FIGS. 5A and 5B illustrate isolation, FIGS. 6A and 6B illustrate gain, and FIGS. 7A and 7B illustrate radiation efficiency. The band of the antenna conductor pattern 20 is from 2.4 GHz to 2.484 GHZ, and the band of the antenna conductor pattern 10 is from 6.2 GHz to 8.3 GHZ. As can be seen from the graphs of 4A and 4B to FIGS. 7A and 7B, both the antenna conductor patterns 10 and 20 are satisfactory in terms of return loss, isolation, gain, and radiation efficiency.

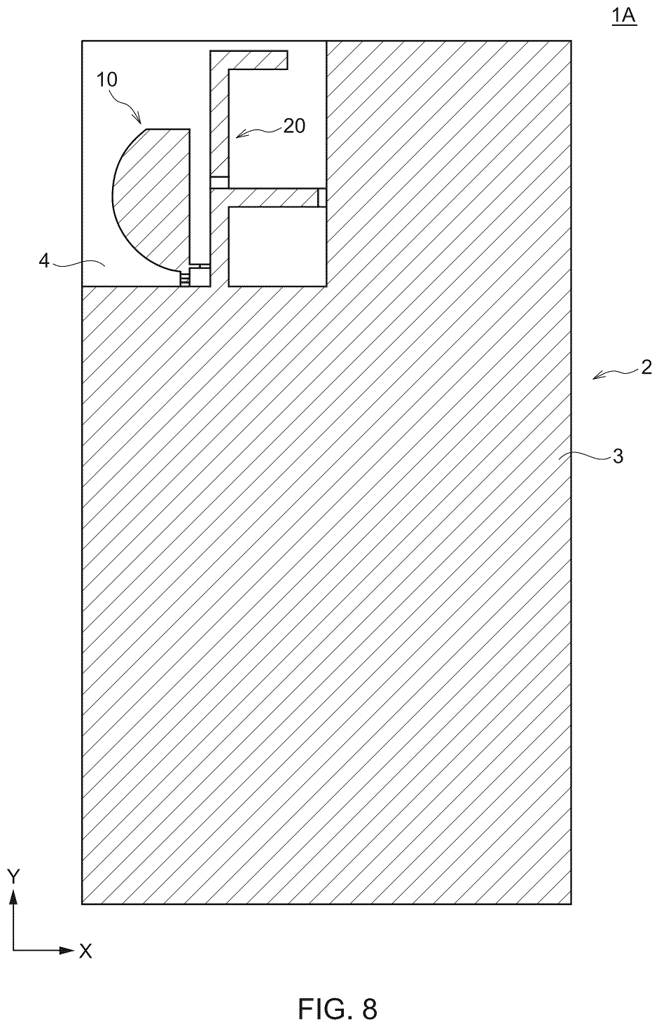

FIG. 8 is a schematic plan view illustrating the outer appearance of an antenna device 1A according to a first comparative example.

As illustrated in FIG. 8, the antenna device 1A according to the first comparative example differs from the antenna device 1 according to the above embodiment in that the capacitive element C is connected to the vicinity of the negative Y-direction end portion of the radiation patterns R1. In the antenna device 1A according to the first comparative example, the capacitive element C is connected outside the range between ±λ/20 from the center position P.

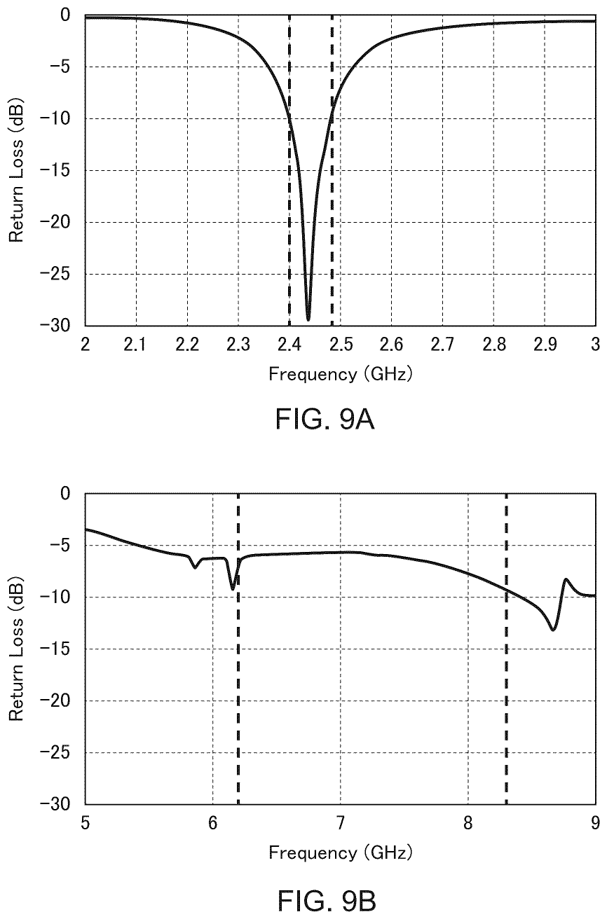

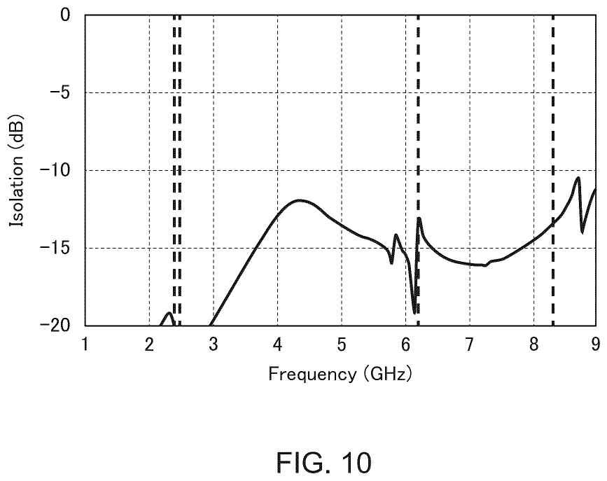

FIGS. 9A and 9B and FIG. 10 are graphs illustrating the characteristics of the antenna device 1A according to the first comparative example. More specifically, FIG. 9A illustrates the return loss of the antenna conductor pattern 20, FIG. 9B illustrates the return loss of the antenna conductor pattern 10, and FIG. 10 illustrates the isolation between the antenna conductor patterns 10 and 20. As can be seen from FIGS. 9A and 9B and FIG. 10, in the antenna device 1A according to the first comparative example, the return loss of the antenna conductor pattern 20 and the isolation between the antenna conductor patterns 10 and 20 are satisfactory, whereas the return loss of the antenna conductor pattern 10 is inferior to that of the antenna device 1 according to the above embodiment.

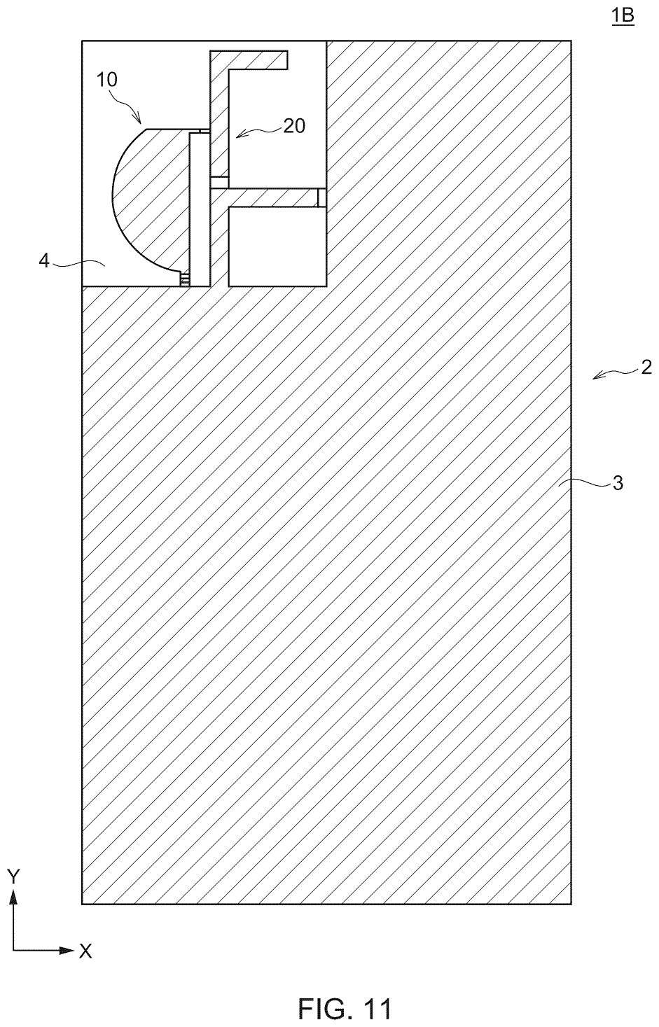

FIG. 11 is a schematic plan view illustrating the outer appearance of an antenna device 1B according to a second comparative example.

As illustrated in FIG. 11, the antenna device 1B according to the second comparative example differs from the antenna device 1 according to the above embodiment in that the capacitive element C is connected to the vicinity of the positive Y-direction end portion of the radiation patterns R1. In the antenna device 1B according to the second comparative example, the capacitive element C is connected outside the range between ±λ/20 from the center position P.

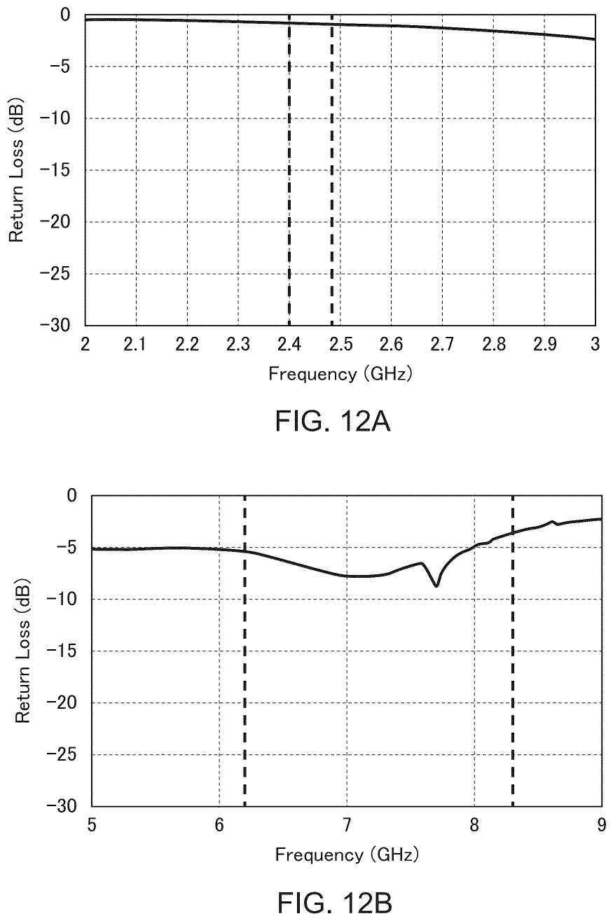

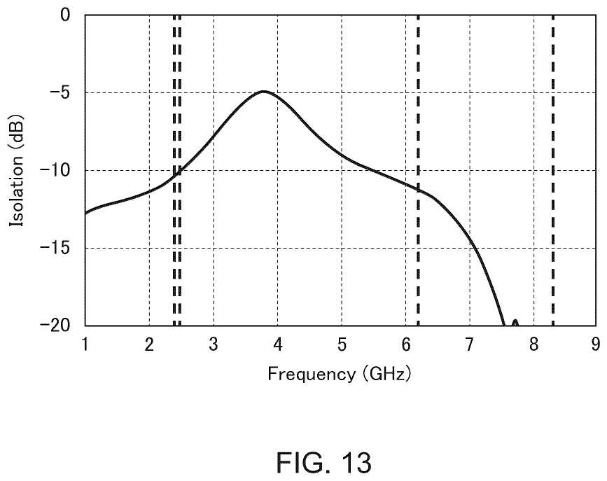

FIGS. 12A and 12B and FIG. 13 are graphs illustrating the characteristics of the antenna device 1B according to the second comparative example. More specifically, FIG. 12A illustrates the return loss of the antenna conductor pattern 20, FIG. 12B illustrates the return loss of the antenna conductor pattern 10, and FIG. 13 illustrates the isolation between the antenna conductor patterns 10 and 20. As can be seen from FIGS. 12A and 12B and FIG. 13, in the antenna device 1B according to the second comparative example, the isolation between the antenna conductor patterns 10 and 20 is satisfactory, whereas the return loss of the antenna conductor patterns 10 and 20 is inferior to that of the antenna device 1 according to the above embodiment.

As described above, the antenna device 1 according to the present embodiment has a configuration in which the antenna conductor patterns 10 and 20 having mutually different resonance frequencies are provided in the ground clearance area 4. Further, the capacitive element C connecting the antenna conductor patterns 10 and 20 is inserted within a range between ±λ/20 from the center position P. With the above configuration, it is possible to cancel inductive coupling generated between the antenna conductor patterns 10 and 20, thereby making it possible to achieve high isolation while satisfying various characteristics such as return loss, gain, and radiation efficiency.

While some embodiment of the present disclosure has been described, the present disclosure is not limited to the above embodiment, and various modifications may be made within the scope of the present disclosure, and all such modifications are included in the present disclosure.

The technology according to the present disclosure includes the following configuration examples but not limited thereto.

An antenna device according to an aspect of the present disclosure includes: a substrate; a ground conductor formed on the surface of the substrate; first and second antenna conductor patterns arranged in a ground clearance area on the substrate surface, which is obtained by cutting out the ground conductor; and a capacitive element connecting the first and second antenna conductor patterns. The first antenna conductor pattern includes a first radiation pattern extending in a first direction from a first feed point. When a wavelength with respect to the center frequency of an electromagnetic wave in wireless communication using the first antenna conductor pattern is λ, the capacitive element is connected within a range between ±λ/20 from the center position of the first radiation pattern in the first direction. With this configuration, the capacitive element cancels inductive coupling generated between the first and second antenna conductor patterns, thereby making it possible to achieve high isolation between the first and second antenna conductor pattern. Further, since the capacitive element is connected within the range between ±λ/20 from the center position in the first direction of the first radiation pattern, it is possible to achieve satisfactory return loss characteristics. Thus, it is possible to provide an antenna device achieving sufficient isolation between antennas while satisfying the return loss characteristics.

In the above antenna device, the ground clearance area may be surrounded by a first edge of the ground conductor extending in the first direction, a second edge of the ground conductor extending in a second direction perpendicular to the first direction, and edges of the substrate. This allows the first and second antenna conductor patterns to be disposed in the vicinity of the end portion of the substrate, facilitating reduction in the entire size of the antenna device.

In the above antenna device, the first radiation pattern may have an opening end positioned on the opposite side of the first feed point in the first direction, and the first radiation pattern may have an area whose width in the second direction gradually increases from the first feed point toward the center position and an area whose width in the second direction gradually reduces from the center position toward the opening end. This can widen the band of the first radiation pattern.

In the above antenna device, a portion at which the width in the second direction of the first radiation pattern becomes maximum may be positioned within the range between ±λ/20 from the center position. This can widen the band of the first radiation pattern.

In the above antenna device, the first antenna conductor pattern may further include a first conductor pattern connected to the first feed point, and a first inductance element may be connected between the first conductor pattern and the first radiation pattern. This can reduce the return loss of the first antenna conductor pattern.

In the above antenna device, the second antenna conductor pattern may include a second conductor pattern extending in the second direction from a second feed point toward the first antenna conductor pattern, a third conductor pattern extending in the first direction from the second conductor pattern toward the second edge of the ground conductor, and a second radiation pattern extending in the first direction from a connection point between the second and third conductor patterns toward the opposite side of the second edge of the ground conductor. This can improve the radiation efficiency of the second antenna conductor pattern.

The above antenna device may further include a second inductance element connected to the second radiation pattern. This can reduce the return loss of the second antenna conductor pattern.

In the above antenna device, one and the other ends of the capacitive element may be connected respectively to the first radiation pattern and between the second inductance element and the second feed point. This allows adjustment of the return loss of the first and second antenna conductor patterns and isolation between the first and second antenna conductor patterns.

In the above antenna device, the second inductance element may be a two-terminal type chip component mounted on the substrate and having first and second terminals, and the first and second terminals of the second inductance element may be connected respectively to the second radiation pattern and a connection point between the second and third conductor patterns. Thus, it is possible to achieve a sufficient inductance by using the small-sized second inductance element and to reduce a variation in the inductance value.

In the above antenna device, one and the other ends of the capacitive element may be connected respectively to the first radiation pattern and between the second and third conductor patterns. This allows adjustment of the return loss of the first and second antenna conductor patterns and isolation between the first and second antenna conductor patterns.

In the above antenna device, the second radiation pattern may include a first part extending in the first direction and a second part extending in the second direction from the leading end of the first part toward the first edge of the ground conductor. This can reduce the size of the antenna device while reducing influence that the second antenna conductor pattern has on the radiation characteristics of the first antenna conductor pattern.

In the above antenna device, the third conductor pattern may be connected to the second edge of the ground conductor. With this configuration, the second antenna conductor pattern constitutes a reverse F-shaped antenna.

In the above antenna device, at least one of the first and second antenna conductor patterns may have a connection patterns, the capacitive element may be connected to the first antenna conductor pattern or second antenna conductor pattern through the connection pattern, and the pattern width of the connection pattern may be smaller than that of the second antenna conductor pattern. This can reduce influence that the connection pattern has on antenna characteristics.

What is claimed is:

1. An antenna device comprising:
a substrate;
a ground conductor formed on the substrate;
first and second antenna conductor patterns arranged in a ground clearance area on the substrate; and
a capacitive element connecting the first and second antenna conductor patterns,
wherein the first antenna conductor pattern includes a first radiation pattern extending in a first direction from a first feed point, and
wherein, when a wavelength with respect to a center frequency of an electromagnetic wave in wireless communication using the first antenna conductor pattern is λ, the capacitive element is connected within a range between ±λ/20 from a center position of the first radiation pattern in the first direction.

2. The antenna device as claimed in claim 1, wherein the ground clearance area is surrounded by a first edge of the ground conductor extending in the first direction, a second edge of the ground conductor extending in a second direction perpendicular to the first direction, and edges of the substrate.

3. The antenna device as claimed in claim 2,
wherein the first radiation pattern has an opening end positioned on an opposite side of the first feed point in the first direction, and
wherein the first radiation pattern has an area whose width in the second direction gradually increases from the first feed point toward the center position and an area whose width in the second direction gradually reduces from the center position toward the opening end.

4. The antenna device as claimed in claim 3, wherein a portion at which a width in the second direction of the first radiation pattern becomes maximum is positioned within the range between ±λ/20 from the center position.

5. The antenna device as claimed in claim 1,
wherein the first antenna conductor pattern further includes a first conductor pattern connected to the first feed point, and
wherein the antenna device further comprises a first inductance element connected between the first conductor pattern and the first radiation pattern.

6. The antenna device as claimed in claim 2, wherein the second antenna conductor pattern includes a second conductor pattern extending in the second direction from a second feed point toward the first antenna conductor pattern, a third conductor pattern extending in the first direction from the second conductor pattern toward the second edge of the ground conductor, and a second radiation pattern extending in the first direction from a connection point between the second and third conductor patterns toward an opposite side of the second edge of the ground conductor.

7. The antenna device as claimed in claim 6, further comprising a second inductance element connected to the second radiation pattern.

8. The antenna device as claimed in claim 7,
wherein a first end of the capacitive element is connected to the first radiation pattern, and
wherein a second end of the capacitive element is connected between the second inductance element and the second feed point.

9. The antenna device as claimed in claim 8,
wherein the second inductance element is a two-terminal type chip component mounted on the substrate and having first and second terminals,
wherein the first terminal of the second inductance element is connected to the second radiation pattern, and
wherein the second terminal of the second inductance element is connected to a connection point between the second and third conductor patterns.

10. The antenna device as claimed in claim 6,
wherein a first end of the capacitive element is connected to the first radiation pattern, and
wherein a second end of the capacitive element is connected to a connection point between the second and third conductor patterns.

11. The antenna device as claimed in claim 6, wherein the second radiation pattern includes a first part extending in the first direction and a second part extending in the second direction from a leading end of the first part toward the first edge of the ground conductor.

12. The antenna device as claimed in claim 6, wherein the third conductor pattern is connected to the second edge of the ground conductor.

13. The antenna device as claimed in claim 1,
wherein at least one of the first and second antenna conductor patterns has a connection patterns,
wherein the capacitive element is connected to the first antenna conductor pattern or second antenna conductor pattern through the connection pattern, and
wherein a pattern width of the connection pattern is smaller than a pattern width of the second antenna conductor pattern.
